(19) United States
(12) Patent Application Publication
(10) Pub. No.: US 2019/0145128 A1
(43) Pub. Date: May 16, 2019

(54) Anti-tilting transmission mechanism for doors and windows

(71) Applicant: ASSA ABLOY Guoqiang (Shandong) Hardware Technology Co., Ltd., Leling (CN)

(72) Inventors: Yanxia Han, Leling (CN); Baoshuan Wang, Leling (CN); Jianlei Xiao, Leling (CN)

(73) Assignee: ASSA ABLOY Guoqiang (Shandong) Hardware Technology Co., Ltd.

(21) Appl. No.: 16/228,813

(22) Filed: Dec. 21, 2018

(30) Foreign Application Priority Data
Jun. 8, 2018 (CN) 201810587137.X

(51) Int. Cl. E05B 17/00; E05F 11/02; E05C 9/00; E05C 9/04; E05B 3/04; E05B 15/00

(52) U.S. Cl. CPC E05B 17/007; E05F 11/02; E05C 9/004; E05B 59/00; E05B 3/04; E05B 15/0006; E05C 9/041

(57) ABSTRACT

An anti-tilting transmission mechanism for doors and windows includes a first fixed plate, a second fixed plate, a transmission gear located between the first fixed plate and the second fixed plate, and a transmission rack, wherein: two guide though-holes are respectively provided on two ends of the second fixed plate; two threaded columns, which are capable of moving back and forth, are respectively located within the guide though-holes; two limit ribs are respectively located at an outer edge of a rear end of the threaded columns; two compression springs are respectively located between the first fixed plate and the threaded columns; each of the threaded columns has a threaded hole axially provided thereon, so that after passing through a door and window profile, screws are respectively tightened with the threaded holes on the threaded columns, so as to fix the transmission mechanism onto the door and window profile.

### CROSS REFERENCE OF RELATED APPLICATION

The present invention claims priority under 35 U.S.C. 119(a-d) to CN 201810587137.X, filed Jun. 8, 2018.

### BACKGROUND OF THE PRESENT INVENTION

### Field of Invention

The present invention relates to the field of building door and window fittings, and more particularly to an anti-tilting transmission mechanism for doors and windows.

### Description of Related Arts

The door and window transmission mechanism (or the door and window driver) refers to a connector that is mounted on the door and window and realizes transmission between the handle and the locking mechanism.

In the existing transmission mechanism for doors and windows, the threaded hole and the transmission mechanism are generally integrally designed. Since the threaded hole is directly provided on the fixing plate of the transmission mechanism, during an installation and fixation process of the transmission mechanism, after the screw passes through the door and window profile to be tightened with the threaded hole on the transmission mechanism, the transmission mechanism is forced to tilt toward a side where the screw is mounted (namely, toward a transmission handle), which changes the initial installation state of the transmission mechanism, so that a friction between the transmission mechanism and the door and window profile is generated, which affects the use of the transmission mechanism.

### SUMMARY OF THE PRESENT INVENTION

An object of the present invention is to provide an anti-tilting transmission mechanism for doors and windows, which has a reasonable structure and stable installation and is easy to be used, so as to overcome deficiencies of the prior art mentioned above.

The present invention is achieved by a technical solution as follows.

An anti-tilting transmission mechanism for doors and windows comprises: a first fixed plate, a second fixed plate riveted with the first fixed plate, a transmission gear located between the first fixed plate and the second fixed plate, and a transmission rack located between the first fixed plate and the second fixed plate, wherein: a square shaft of a transmission handle passes through the transmission gear of the transmission mechanism for driving the transmission gear to rotate, so as to further drive the transmission rack to move along a straight line; two guide though-holes are respectively provided on two ends of the second fixed plate; two threaded columns, which are capable of moving back and forth, are respectively located within the two guide though-holes; two limit ribs are respectively located at an outer edge of a rear end of the two threaded columns; two compression springs are respectively located between the first fixed plate and the two threaded columns; each of the two threaded columns has a threaded hole axially provided thereon, so that after passing through a door and window profile, screws are respectively tightened with the threaded holes on the threaded columns, so as to fix the transmission mechanism onto the door and window profile.

Preferably, two through-hole seats are respectively located at two ends of the first fixed plate, the two guide though-holes provided on the second fixed plate are respectively corresponding to the two through-hole seats, the two compression springs are respectively sleeved outside the two through-hole seats, and each of the two threaded columns has a recess at the rear end thereof for accommodating each of the two compression springs.

More preferably, in an initial state, each of the two compression springs and each of the two through-hole seats are inserted into the recess at the rear end of each of the threaded columns, so that the threaded columns are located within a cavity defined by the first fixed plate and the second fixed plate riveted with the first fixed plate; with the screwing of the screws, the threaded columns are respectively forced and ejected toward the transmission handle (namely, a side of the transmission mechanism where the screws are mounted) under an action of the two compression swings.

The present invention provides a design concept that the threaded holes for the screws are indirectly provided on the transmission mechanism, and the threaded columns are located between the first fixed plate and the second fixed plate through the compression springs, respectively; when the screws are connected with the transmission mechanism provided by the present invention, factually, the screws are respectively connected with the threaded columns in a threaded screwing manner; due to the indirect contact between the screws and the fixed plates, the second fixed plate of the transmission mechanism only provides each of the two threaded columns with a guide through-hole for guiding, and as a result, the transmission mechanism is not interfered by external forces, that is, the transmission mechanism is not tilted with the screwing of the screws, and is able to maintain an initial installation state, which avoids affecting the use of the transmission mechanism caused by the friction between the transmission mechanism and the door and window profile.

Beneficial effects of the present invention are as follows. In the transmission mechanism provided by the present invention, the two threaded holes for the screws are respectively provided on the two threaded columns for achieving the split structure of the threaded holes and the fixed plates. Compared with the prior art that the threaded holes are directly provided on the fixed plate of the transmission mechanism, due to the indirect contact between the screws and the fixed plates in the present invention, the screws indirectly contact with the fixed plates while the screws are screwed with the threaded holes, the transmission mechanism is not subject to external forces, which ensures that the fixed plates always maintain the initial installation state, so as to effectively prevent the transmission mechanism from tilting during installation, thereby improving installation stability, and avoiding the friction between the transmission mechanism and the door and window profile. Therefore, the present invention is suitable for wide application.

### BRIEF DESCRIPTION OF THE DRAWINGS

The present invention is further explained with accompanying drawings as follows.

FIG. 1 is a schematic diagram of a transmission mechanism provided by the present invention which cooperates with a door and window profile and a transmission handle.

FIG. 2 is a three-dimensionally schematic diagram of the transmission mechanism provided by the present invention.

FIG. 3 is a main view of the transmission mechanism provided by the present invention.

FIG. 4 is an A-A sectional view of the transmission mechanism in FIG. 3.

FIG. 5 is an A-A sectional view of the transmission mechanism in FIG. 3 in an initial state.

FIG. 6 is a sectional view of the transmission mechanism provided by the present invention which cooperates with the door and window profile.

In the drawings, 100: door and window profile; 200: anti-tilting transmission mechanism for doors and windows; 300: transmission handle; 400: screw; 1: first fixed plate; 2: compression spring; 3: threaded column; 4: second fixed plate; 5: through-hole seat; 6: guide through-hole; 7: threaded hole; 8: recess; 9: transmission rack; 10: limit rib.

### DETAILED DESCRIPTION OF THE PREFERRED EMBODIMENT

The present invention will be further described in detail with accompanying embodiments as follows.

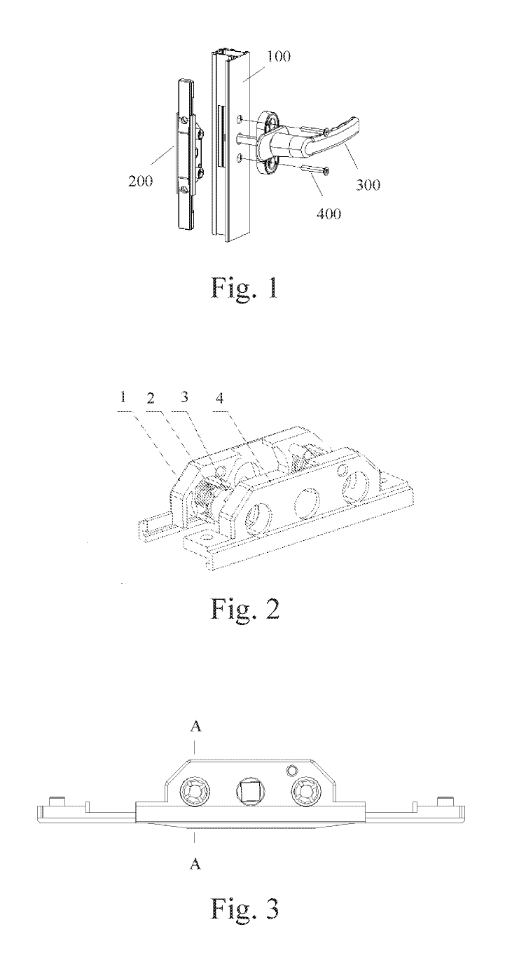

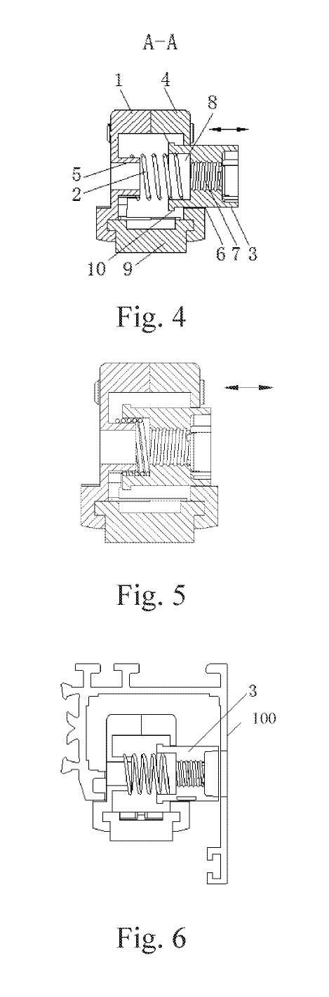

As shown in FIGS. 1-4, an anti-tilting transmission mechanism for doors and windows 200 according to a preferred embodiment of the present invention is illustrated, which comprises a first fixed plate 1, a second fixed plate 4 riveted with the first fixed plate 1, a transmission gear (not shown in the drawings) located between the first fixed to plate 1 and the second fixed plate 4, and a transmission rack 9 located between the first fixed plate 1 and the second fixed plate 4, wherein: a square shaft of a transmission handle 300 passes through the transmission gear of the transmission mechanism 200 for driving the transmission gear to rotate, so as to further drive the transmission rack 9 to move along a straight line, thereby realizing the transmission between the transmission handle 300 and a locking mechanism. Two through-hole seats 5 are respectively located at two ends of the first fixed plate 1, two guide though-holes 6 are respectively provided on two ends of the second fixed plate 4 and are respectively corresponding to the two through-hole seats 5. Two compression springs 2 are respectively sleeved outside the two through-hole seats 5. Two threaded columns 3, which are capable of moving back and forth, are respectively located within the two guide though-holes 6. Two limit ribs 10 are respectively located at an outer edge of a rear end of the two threaded columns 3. Each of the threaded columns 3 has a recess 8 at the rear end thereof for accommodating each of the compression springs 2, and has a threaded hole 7 axially provided thereon. Through screws 400, the transmission mechanism 200 is fixed to a door and window profile 100.

According to the preferred embodiment of the present invention, the transmission mechanism 200 is installed within an aluminum alloy European standard notch; the transmission handle 300 has two screw holes for allowing the screws 400 to pass through the door and window profile 100, so as to fix the transmission handle 300 with the transmission mechanism 200.

In an initial state, each of the two compression springs 2 and each of the two through-hole seats 5 are inserted into the recess 8 at the rear end of each of the two threaded columns 3 of the transmission mechanism 200, so that the two threaded columns 3 are located within a cavity defined by the first fixed plate 1 and the second fixed plate 4 riveted with the first fixed plate 1; with the screwing of the screws 400, the two threaded columns 3 are respectively forced and ejected toward the transmission handle 300 (namely, a side of the transmission mechanism 200 where the screws 400 are mounted) under an action of the two compression springs 2; when the screws 400 are tightened, the two threaded columns 3 contact with the door and window profile 100, as shown in FIG. 6, the compression rings 2 play a support role between both the first fixed plate 1 and the second fixed plate 4 and the two threaded columns 3 to maintain a stable state, so as to ensure that the transmission mechanism 200 is not interfered by external forces, thereby effectively preventing the transmission mechanism 200 from tilting during installation, ensuring installation stability.

It should be noted that the above embodiment is only used to illustrate the technical solution of the present invention and is not intended to be limiting, although the present invention has be described in detail with reference to the preferred embodiment, those skilled in the art should understand that the technical solution of the present invention may be modified or equivalently substituted without departing from the spirit and scope of the technical solution of the present invention which should be included in the protective scope of the claims of the present invention.

What is claimed is:

1. An anti-tilting transmission mechanism for doors and windows comprising: a first fixed plate (1), a second fixed plate (4) riveted with the first fixed plate (1), a transmission gear located between the first fixed plate (1) and the second fixed plate (4), and a transmission rack (9) located between the first fixed plate (1) and the second fixed plate (4), wherein:
two guide though-holes (6) are respectively provided on two ends of the second fixed plate (4); two threaded columns (3), which are capable of moving back and forth, are respectively located within the two guide though-holes (6); two limit ribs (10) are respectively located at an outer edge of a rear end of the two threaded columns (3); two compression springs (2) are respectively located between the first fixed plate (1) and the two threaded columns (3); each of the two threaded columns (3) has a threaded hole (7) axially provided thereon, so that after passing through a door and window profile, screws are respectively tightened with the two threaded holes (7) on the two threaded columns (3), so as to fix the transmission mechanism onto the doors and windows.

2. The anti-tilting transmission mechanism for the doors and windows, as recited in claim 1, wherein: two through-hole seats (5) are respectively located at two ends of the first fixed plate (1), the two guide though-holes (6) provided on the second fixed plate (4) are respectively corresponding to the two through-hole seats (5), the two compression springs (2) are respectively sleeved outside the through-hole seats (5), and each of the two threaded columns (3) has a recess (8) at the rear end thereof for accommodating each of the compression springs (2).

3. The anti-tilting transmission mechanism for the doors and windows, as recited in claim 2, wherein: in an initial state, each of the two compression springs (2) and each of the two through-hole seats (5) are inserted into the recess (8) at the rear end of each of the two threaded columns (3), so that the two threaded columns (3) are located within a cavity defined by the first fixed plate (1) and the second fixed plate (4) riveted with the first fixed plate (1); with screwing of screws, the threaded columns (3) are respectively forced and ejected toward a transmission handle under an action of the compression springs (2).
